(19) United States
(12) Patent Application Publication
(10) Pub. No.: US 2004/0006541 A1
(43) Pub. Date: Jan. 8, 2004

(54) Method and system for purchasing broadcast content

(75) Inventors: Brant Huddelston, Midlothian, VA (US); David Carl Loose, Austin, TX (US); Mark Patrick Nuttal, Victoria (AU)

Correspondence Address: Richard A. Tomlin, IBM Corporation, (Internal Zip 40416), 8051 Congress Avenue, Boca Raton, FL, 33487, US

(73) Assignee: International Business Corporation, Armonk, NY

(21) Appl. No.: 10/192,436

(22) Filed: Jul. 8, 2002

(51) Int. Cl. H04K 1/00

(52) U.S. Cl. 705/51

(57) ABSTRACT

A system and method of making broadcast content selectively available to users in different forms, including a system for charging and collecting compensation for at least one form. Broadcast content such as digital music or other information or entertainment is sent out in a protected form and receiving devices may be provided with different keys to unlock the content for long-term storage. The receiver also includes a system for requesting additional rights (such as permanent storage and playing of the content) and for compensating for that additional set of rights. When the user's request is received with the necessary compensation, the user is provided a permission for the greater rights and a method of accessing those rights; otherwise, the content is provided in an ephemeral form and ceases to exist on the users machine.

### CROSS REFERENCE TO RELATED PATENTS

The present invention is related to the following documents, each of which is specifically incorporated herein by reference:

U.S. patent application Ser. No. 09/152,756 (docket SE9-98-006) entitled “Secure Electronic Management System.” filed Sep. 14, 1998 by Gruse et al and assigned to International Business Machines. This patent is sometimes referred to herein as the Content Delivery Patent.

U.S. patent application Ser. No. 09/177,096 (docket SE9-98-009) entitled “System for Tracking End User Electronic Content” filed Oct. 22, 1998 by Gary Gruse et al. and assigned to International Business Machines. This patent is sometimes referred to herein as the Content Tracking Patent.

U.S. Pat. No. 5,734,719 entitled “Digital Information Accessing, Delivery and Production System” issued Mar. 31, 1998 to James T. Tsevdos et al. and assigned to International Business Machines Corporation. This patent is sometimes referred to as the Content Download Patent.

U.S. Pat. No. 6,173,112 entitled “Method and System for Recording In-Progress Broadcast Programs” issued Jan. 9, 2001 to George G. Gruse et al. and assigned to International Business Machines Corporation. This patent is sometimes referred to as the Broadcast Patent.

U.S. Pat. No. 5,319,705 entitled “Method and System for Multimedia Access Control Enablement” issued Jun. 7, 1994 to Halter et al. and assigned to International Business Machines Corporation. This patent is sometimes referred to as the Content Selection Patent.

U.S. Pat. No. 5,757,907 entitled “Method and Apparatus for Enabling Trial Period Use of Software Products” issued May 26, 1998 to Cooper et al. and assigned to International Business Machines Corporation. This patent is sometimes referred to herein as the Trial Period Patent.

### BACKGROUND OF THE INVENTION

1. Field of the Invention

The present invention is related to improvements in delivering protected content electronically. More particularly, the present invention relates to the delivery of digital information or content (such as music) through secure broadcast transmission while allowing the recipient to acquire additional rights (such as unlimited playback and/or the right to make a permanent recording) to content selected by the recipient. Thus, the radio receiver allows both temporary reception, storage and playing of broadcast content as well as long-term storage and playing of content selected by the recipient. The player also has the capability to change format/protection and offload to another storage or player, as the long term storage and playback need not be limited to being internal to the receiving device.

2. Background Art

Various systems are known in the prior art for providing content to a user upon his request.

An example of these systems is shown and described in the Content Delivery Patent and the Content Tracking Patent which are referenced above. In each of these systems, a user can use a network to contact an electronic store to determine what content (e.g., music) is available and place an order for such content to be delivered to him through the use of a data transmission network such as the Internet (or through a wireless system).

In the Content Download Patent referenced above, content such as music or video may be available for download through a data transmission network. A customer connects over a network and determines, perhaps from available previews including audio and/or video segments, the content he wishes to acquire which is then delivered over a data transmission network.

The Broadcast Patent describes a system in which a program in progress is selected and a record command issued to record the program presently being broadcast, with the end of the program detected and the recording terminated.

None of the foregoing references describes a system which provides for information transfer over a broadcast medium for temporary use with the option of acquiring additional rights, e.g., to store and reuse the content.

It is desirable to provide information to provide a system where content such as entertainment is provided for temporary use so that a user can select content for which he wishes to obtain additional rights. It is also desirable that such additional rights be in a form easily usable by the purchaser within the scope of the rights purchased but difficult to use outside the rights purchased—either by a different user or after a time period which has been specified as permitted for the rights which the user has acquired.

The Content Selection Patent describes a system in which a plurality of software products are encrypted using different keys and then a user who wishes to purchase one product but not another is provided a key selected to unlock the selected software.

The Trial Period Patent describes a system in which software (such as is described in the Content Selection Patent) is made available for a brief period for a trial use before the purchase is made. Based on the trial the user can either purchase a license for the software or he can let the trial period and the ability to use the content expire.

Various systems have been proposed for securely delivering digital content with limitations such as usage rights attached, e.g., over a network in response to a user's request or on a CD where a key is provided for selective access, either on a permanent or a temporary basis. However, the systems do not provide a system in which broadcast content is made available to a receiver and the user can select to receive additional rights to that content by sending a reply message (with any necessary compensation) back to the transmitter and receive additional rights.

Accordingly, the prior art systems have undesirable disadvantages and limitations and do not accomplish the states objectives of a desirable system for delivering content for different categories of use, e.g., temporary and permanent use.

### SUMMARY OF THE INVENTION

The present invention is an improved method and system for the distribution of content through broadcast transmission of content which method and system allows a user to purchase of additional rights in the content.

The present invention overcomes the disadvantages and limitations of the prior art systems for providing content in that it does not require a separate physical connection to a network such as the Internet (or the World Wide Web) for delivering purchased content. That is, when content is ordered, the content itself does not have to be reshipped to the customer.

The present invention has the advantage that it allows for some rights to be provided at little or no charge while providing other rights or conversion to less restricted format only upon payment of additional consideration.

An additional advantage of the present invention is that content may be provided for current enjoyment while allowing for purchase by a listener of additional rights (recording for later playback, for example, or for providing a hard copy of the content.

A third advantage of the present system is that content may be secured against improper use and distribution while allowing for the playing on a temporary basis of the content on an entertainment device such as a radio or a computer.

The present invention is a system which broadcasts content and allows a received to identify selected content for which additional rights are desired and are obtained in return for consideration.

The present invention has an additional advantage that the additional rights may be passed along to a user without sending the content to the user an additional time. Such a reuse of the broadcast content avoids the necessity of finding the content at a central location, transmitting it and receiving it at the receiver a second time. This saves not only processing of content (which may be a good-sized file and involving searching a large mass storage) at both the central location and the receiver. This saves not only bandwidth of transmission, meaning that the content may be transmitted once to all receiver, then as orders arrive at different times from different receivers, avoiding the necessity to retransmit the content to each receiver (which could involve many transmissions at different times to different receivers). Advantageously also, a portion of the content may be available for review at the time of purchase without having to transmit the content an additional time, so the user may confirm that he has selected the correct content for purchase. Thus, the present system and method has the advantage that content may be broadcast a single time and stored so it may be used to confirm the purchase and so that the purchased copy may be used, all from the initial transmission.

The present invention may be viewed as “one stop shopping” allowing an impulse purchase of content. For example, when the customer hears music, he can hear it, decide that he likes it, “purchases” it all almost simultaneously and without having to find a vendor (a music store, on-line vendor or record club, for example), figure out what the content is (by name and artist), make a purchase, then get the music. While a music store may provide quick access to the music once the music store is found and the desired material is located, transactions with others may involve waiting for material to be shipped.

The operating features of the present invention provide a broadcast of content using conventional broadcasting techniques such as are becoming in widespread use with digital, encrypted broadcast which have limited applicability to conventional AM or FM radio transmissions (AM or FM radio transmissions are primarily analog, and without physical restrictions on saving and copying and playing content). These broadcasting techniques for radio and/or television signals (audio and/or video) may be through either wireless (electromagnetic waves through/antennas, possibly including satellite retransmission) or through wired connections (such as cable) and include an identification of the material and allow for a return message to originate with the receiver. (The reader should note that any return message/transaction may be addressed to a different party, such as a clearinghouse or other sales activity.) The return message indicates a selection of content for which broader rights are desired along with a method of conveying compensation for such broader rights. Upon receipt of the message that a particular user wishes to purchase additional rights, any associated payment is collected and a message is forwarded which allows the particular user to enjoy the additional rights purchased without allowing for others to improperly use those additional rights.

The present invention is based on a premise that a user or listener can review enough of the content to make a “buy” decision and any technique that allows this to happen is considered a part of the present invention. In some instances, the content may be a portion or “clip” of the content and in other systems the content for preview may be sent in an analog stream, then converted to digital in the receiving device and stored (in a convenient format such as MP3). While this may result in a somewhat diminished quality, the result is the same (allowing the user to “hear and buy”) and this would allow a convention AM or FM station to offer the service without changing to a digital transmission system.

While the present invention is described somewhat specifically in the context of the preferred embodiment of music being broadcast using radio signals, the present invention is not limited to the type of content being provided or the type of transmission. It is suitable for use not only with music content (as described in connection with the embodiment described later) but also with video or text transmissions (or even the delivery of software, like an application program, to one's personal computer) (and can use radio or networked transmissions or even allow content to be ordered for “mailed” distributions, as in CD distribution) and need not be provided as radio signals but may be provided as television signals, cable transmissions or in the form of digital signals rather than analog signals.

In addition to allowing for individual purchases to be made, the present invention also allows for the enablement of other “purchases” of digital content. For example, a purchase could allow for a single payment to allow for unlimited content purchases of material transmitted during a selected time period. Alternatively, a single payment could allow for the user to keep a certain amount of content (either by time or by units, such as songs). In either case, the transaction may allow for the perpetual use of material or for some limited use of the material (for example, by the number of plays, by the time of retention (play for the next month) or for the preparation of a limited number of tangible copies) using conventional digital rights management techniques such as are described in the documents referenced in the Cross Reference to Related Patents, including the Content Delivery Patent and the Content Tracking Patent references above. In the case of multiple content purchases, such as an unlimited content purchase, suitable modifications to the system described would be apparent to one skilled in the art and allow for the permanent storage without sending specific messages for each transaction.

Other objects and advantages of the present invention will be apparent to those skilled in the relevant art in view of the following description of the preferred embodiment, taken together with the accompanying drawings and the appended claims.

### BRIEF DESCRIPTION OF THE DRAWINGS

Having thus described some objects and advantages of the present invention, the present invention of an improved amplifier system and method is described in connection with the accompanying drawings in which:

FIG. 1 is a view of a portion an automobile dashboard, showing a radio receiver with a user interface and associated speakers;

FIG. 2 is a block diagram of a radio receiver system and its associated logic with the radio of FIG. 1;

FIG. 3 illustrates a typical flow diagram for the system described and shown in connection with the foregoing FIGS. 1 and 2;

FIG. 4 illustrates a digital signal packet for transmission to the radio receiver of the present invention;

FIG. 5 illustrates a digital signal packet for transmission from the radio receiver of the present invention to order content; and

FIG. 6 illustrates a digital signal packet response to the ordering of content by the radio receiver of the present invention.

### DETAILED DESCRIPTION OF THE PREFERRED EMBODIMENT

In the following description of the preferred embodiments, the best implementations of practicing the invention presently known to the inventor will be described with some particularity. However, this description is intended as a broad, general teaching of the concepts of the present invention using several specific embodiments, but it is not intended to be limiting the present invention to the implementation as shown in any of these embodiments, especially since those skilled in the relevant art will recognize many variations and changes to the specific structure and operation shown and described with respect to these figures.

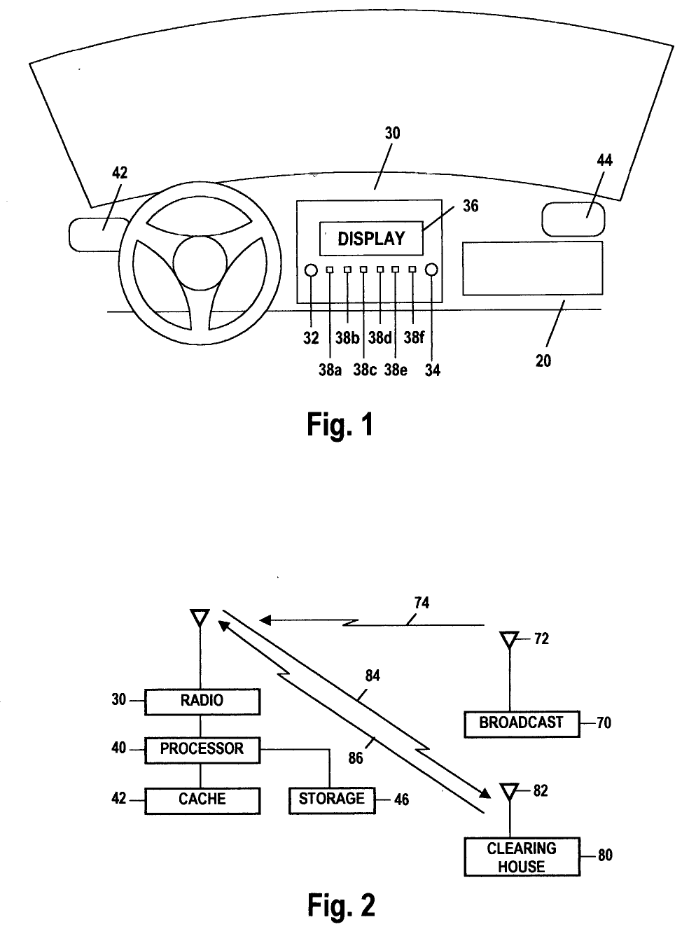

FIG. 1 illustrates the front portion 10 of an automobile with its dashboard 20 including a radio receiver 30 and speakers 42, 44. An antenna (not shown in this view) is electrically coupled to the radio receiver 30 and allows for broadcast signals to be received and played through the speakers 42, 44 as well as to be sent from the radio receiver 30. Such radio antennas are conventional in automobiles and are mounted to the exterior of the auto in a convenient location such as one fender, within or mounted to one of the pieces of exterior glass or on the roof or bumper, coupled in an event to the radio receiver using conventional techniques such as a signal-carrying cable.

The radio receiver 30 includes a first control knob 32, a second control knob 34, a display region 36 and a plurality of push buttons 38a, 38b . . . 38g, with the number and location of pushbuttons being somewhat a matter of design choice. However, the radio's pushbuttons (referred to collectively as 38) in general serve as an input device to the radio receiver 30 as will be described in detail elsewhere in this document. Of course, while this invention is discussed in the context of conventional broadcasting, it is applicable to the new types of digital radio receivers such as XM, and Sirius Satellite digital radio receivers which are known in the marketplace.

The control knobs 32, 34 of the radio receiver 30 serve a conventional purpose for controlling the operation of the radio receiver, in that they control the volume and the tuning for normal operation of the radio receiver 30. The control knobs 32, 34 also serve a secondary purpose to select content for further rights as will be described elsewhere in this document.

The push buttons 38 serve a normal function of selecting a station in the normal operation of the radio receiver, where a selected frequency may be set to be associated with one of the push buttons, then recalled by pushing that one of the push buttons. Of course, conventional radio receivers may be replaced by other user interfaces, such as voice control in the future, and suitable modifications to the present invention can easily be made without departing from the spirit of the present invention.

The radio push buttons 38 are also used in the ordering mode of the present invention to select one piece of stored content and for entering an account number or credit card information for payment or billing. That is, when the user wishes to purchase rights to content such as a song which has recently been broadcast, the user selects that song based on information displayed: the current song, the previous song, the song before that etc. Then, the user may be offered the chance to hear a portion of the material to confirm that the correct content has been selected; depending on the capabilities of the system this may be an option, if desired. (In a system where the user can select only the present piece or the previous piece, the user is unlikely to become confused and errors in selection are unlikely, but if the system allows for any of the past 10 pieces to be selected, playing a portion or otherwise identifying it, as by displaying the title, may be desirable to confirm that the right piece has been selected.) Once the user has selected content to be purchased and confirmed the selection, the user is prompted to enter his account number using the push buttons 38a, 38b . . . 38f. by appropriate message on the display. The actual entering of and securing of account numbers and credit card information is actually somewhat time-consuming and subject to security concerns and ideally such information would be entered once, then stored (securely) for future use. Such account and/or charge information may be stored in a convenient place in the system, typically in the back end servers or elsewhere, but may be stored in a storage associated with the receiver for use with different broadcasting systems, if desired.

FIG. 2 shows a block diagram of a content broadcast system of the present invention. The radio receiver 30 has an antenna 60 associated with it for receiving a signal 74 including digital content transmitted from the broadcast facility 70 through an antenna 72 associated with the broadcast facility 70. A clearinghouse 80 with a transceiver antenna 82 exchanges messages with the radio receiver 30, with messages from the radio receiver being depicted by the reference numeral 84 and messages from the clearinghouse 80 to the radio receiver being depicted by the reference numeral 86.

The radio receiver is shown with its processor 40 coupled to a cache 42 and storage 44. As content is received, it is stored in the cache 42 (or temporary storage). The content may be played as it is cached or buffered for later playing the first time. In this latter case where the cache 42 serves as a buffer storage before the first play, the processor 40 removes content from the cache 42 and processes for its first-time playing, including decrypting it using a key which it stores for use in decrypting the content in a secure fashion. The decrypted content is then played once in a conventional manner, using, for example, a digital content player, such as are available for rendering music content from RealNetworks, WinAmp, Liquid Audio or similar player. For rendering other types of digital content, an appropriate and generally available tool will be used, and neither the type of content nor the type of rendering tool forms an essential part of this invention. Similarly, it is assumed that the content is protected in a known manner such as encryption using a key, and the present invention is not dependent on the type of protection which is employed, so the designer may select the type of protection that suits his design and may use either public key encryption, private key encryption with a universal or a session key, or may use another form of protection, such as Pretty Good Protection (also called PGP). It is anticipate that the user environment will be protected in some manner to keep content from being “ripped” using snooping devices and there are many conventionally known and easily available tools to accomplish this, but, again, the present invention is not dependent on the form of protection which is selected to make it difficult for the user to get to the content in the clear.

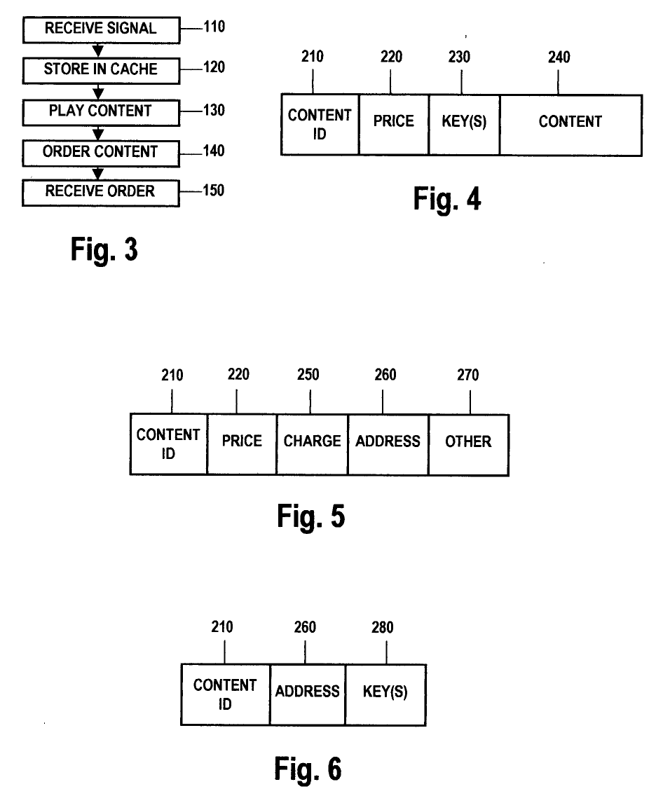

FIG. 3 is a flow diagram of the process of the present invention. The broadcast signal from the broadcast station is received at block 110 and stored at block 120 in a temporary storage or cache (represented by 42 in FIG. 2). Periodically the processor 40 removes content from the cache 42, decrypts the content and prepares it for playing at block 130. A consumer who is enjoying the content may enter a request for additional rights using the push buttons 38 and/or control knobs 32, 34 to indicate a desire to obtain additional rights. The process of “ordering content” or acquiring additional rights is depicted at the step 140 in FIG. 3 and uses the messages of FIGS. 4-6 as will be discussed. The cache storage provides only temporary storage and as such may be relatively small and cyclical, that is, as new content is receives, it is stored over the old content and destroys the old content. The amount of storage in the cache 42 depends on its size, the type of content being provided and the method of compression used but will generally be in the range of a few minutes to a few hours of content to provide a buffer of content and to allow for a limited archive of recently-received content which is available for “purchase”, all maintained in a protected environment to prevent unauthorized “copying”. The user who indicates that he wishes to purchase content is then prompted to select which content he wishes to purchase: the content currently being played, the previous content, etc. In the case of a radio broadcasting music, this may mean the current song, the previous song, or the one before that, but this method of identifying content becomes somewhat confusing when a radio broadcast may include commercials, news and weather reports and other material such as commentary, so the system advantageously offers the user the chance to review the material selected: a clip of the music, a segment of a video, a paragraph of text content, etc., to prevent the user from ordering rights in the wrong material. Once the user has selected the material, the push buttons are used to identify an account number, a credit card, a checking account or debit account, etc., preferably based on information which has been previously stored in the system and a message is sent (in the format of FIG. 5) to the clearinghouse 80 (see transmission 84 in FIG. 2). The clearinghouse confirms the payment information and sends a reply message in the format of FIG. 6) to the radio receiver 30 which allows the processor to copy the selected content from the cache 42 into the permanent storage 44 and to record in storage any necessary information (such as a decryption key and usage rights) for the material purchased.

FIGS. 4, 5 and 6 are examples of messages which are transmitted in employing the present invention; since the techniques for communicating may be conventional and the format and content may be changed as desired, their format is shown for illustrative purposes for the sake of providing an embodiment to carry out the present invention. Since any technique for providing a request, identifying the content and the requesting unit and providing for a method of payment will suffice for the present invention, the details of these messages may be outside the present invention. FIG. 4 is an example of the content message which is transmitted from the broadcast source 70. FIG. 5 is a message which is sent to order rights in the broadcast content (sent to the clearinghouse 80) and FIG. 6 is a return message (from the clearinghouse 80).

In FIG. 4 the transmission of content includes a content identifier (ID) 210, price information 220 for purchase of additional rights to the content, one or more keys 230 for opening the content and the content itself 240. Optionally, the content may include information about related content (identification of a clip or a section of text) and the price information may have information about different prices for different rights (one price for a local copy, a different price for a copy which can be used for a 30 day period, a price for a clip, a price for a download copy on a CD, etc., as the parties may be interested in providing options for “purchase” of the content. The content may also be “serialized” and contain identifiers to other portions which are related (a part 2 of a video, a later portion of a sports event such as a football game or a basketball game which are broadcast in halves or other portions, etc.) so the user can consider purchasing the related content as well.

FIG. 5 illustrates a message from the radio receiver 30 to a “store” or clearinghouse for payments and purchase information. After the user has selected the content which he wishes to purchase, agreed to the price and provided payment information, that information is assembled into a message which is then formatted and sent (with encryption, if desired, and with content integrity information, if necessary to insure that the message is received complete and unaltered) in the form as shown in this FIG. 5 wherein the content ID 210 is provided, the price 220 (since different prices may have been quoted at different times or to different users), the payment information in the form of a charge account such as Visa or MasterCharge or in terms of a debit to an existing account known to the clearinghouse or a debit to a checking account which may be accomplished in the form of an ACH debit). The message also includes the necessary address information 260 (such as an IP address for sending the confirmation of the transaction as well as the address of the clearinghouse, if needed) and may include other optional information 270 such as the name of the purchaser, expiration of the credit card, PIN number for the transaction, etc.

The clearinghouse receives the message and determines whether ti is correct and if it will be accepted (for example, by determining that the charge account is valid or that an account to be debited has the necessary funds). If the clearinghouse decides to honor the request for payment, then a return message is sent to back to the user, a message which includes the content ID 210, the address 260 of the requestor and the necessary key(s) for opening the content and rendering it as well as the necessary permission to move the content from the temporary storage (the cache) to a more permanent storage associated with the user's processor and radio device.

The provision of material which is broadcast and saved to a cache inherently provides a short term storage which disappears as new content is received and overwritten onto that portion of the cache. In addition to this form of making the broadcast material available to the user only temporary (since the temporary or cache storage is limited), it is possible to provide a key which is erased after a period of time or to provide usage rights which specify that the right to use the broadcast content is only permitted for a limited time period (which can be expressed in any format desired, for a matter of mere seconds to a fixed period of several days) as is described in the materials identified above. It is also possible to permit usage of the content only a fixed number of times, which might be as low as only one time or as many as desired, either alone or in combination with other controls. Obviously, the system as described in the incorporated material describes systems for restricting unauthorized copying of content, including the prohibition of “snooping” as content is being rendered and copying the content down. While such systems make improper access to the content less likely by making it difficult to determine how the content is protected and how it is controlled, no system is perfect or foolproof and one or more dedicated people may find ways around some or all of the controls, with enough time and effort. However, the time and effort are not free and must be balanced against the cost of higher protection. Further, in many countries, there are criminal provisions against unauthorized copying or defeating copy protection schemes which mean that those attempting to make unauthorized copies are subject to criminal and/or civil penalties which are quite substantial and serve as a deterrent.

Of course, many modifications of the present invention will be apparent to those skilled in the relevant art in view of the foregoing description of the preferred embodiment, taken together with the accompanying drawings and the appended claims. For example, the content which is provided has been described in its preferred embodiment in connection with a radio broadcast of music, but the present invention is not limited to music content and other forms of content including news, video, or other information or events including sports contests, performances and other activities may be broadcast and offered to customers for fees. Further, the present invention is not limited to transmission using radio technology, where forms of electromagnetic transmissions at other frequency such as short wave, television and citizen bands could also be used to advantage in certain situations. Also, it will be appreciated that the transmission and reception of such content could be accomplished over a wired connection as well as using wireless technology and could be accomplished using satellite, phone lines, the Internet or dedicated wiring systems such as cable networks. Also, another signal processor could be used to advantage as the receiver, which might be a computer with speakers and appropriate software, and that computer could be any size, from a mainframe to a desktop to a laptop to an even smaller computer such as a handheld (palm-sized such as a PDA or a cell phone) to a wearable computer, as desired by the application and the user. Further, some elements of the present invention can be used to advantage without the corresponding use of other elements (the cache provides certain advantages in some cases, but in others the direct playing of content can be used to advantage if it occurs as the system is prepared to render it). Further, the use of a portion of the content to confirm that the correct digital content has been identified is, of course, optional, and other identifiers such as the title could be provided to the user so that the user can confirm that he has selected the correct data. The use of a separate clearinghouse may be desirable in many instances, but in a small system the functions of the clearinghouse could be performed by the broadcasting system. Also, while the present system has been described in connection with real time messages, the system could operate in a disconnected mode where the “orders” for content are entered as desired but transmitted to the clearinghouse later as a part of a batch. Further, the present invention may be modified to be useful in a superdistribution system where the user is empowered to make copies for distribution to others as long as appropriate protection is contained in the copy and as long as each copy is paid for. The present invention has been described in detail in connection with a “push button” type of user interface system for user input (in selecting material, for example, and for ordering) while the present invention is not so limited and any other suitable user interface could be used to advantage in the present invention. For example, a touch screen could received the user input as well as the push buttons and a voice recognition system could also be used to receive and process user inputs. Further, while the push buttons are one way to enter credit card or account information in the system, these could also be entered into an onboard system in other ways and the payment information could be identified to the vehicle (its VIN number which is unique). Further, since the present invention contemplates that spoken commands could be used to initiate a transaction, voice recognition could be used in the present invention to identify the speaker and to charge the account of the speaker and to verify the transaction. While the description contained in this disclosure is necessarily somewhat specific to provide an enabling teaching of one embodiment, those skilled in the art would be aware of many modifications and adaptations to the present invention to achieve a similar result. Accordingly, the foregoing description of the preferred embodiment should be considered as merely illustrative of the principles of the present invention and not in limitation thereof.

Having thus described the invention, what is claimed is:

1. A content rendering system which receives content from a broadcasting system which distributes content in an unusable form, the rendering system comprising:
a storage which stores the content in short term memory as distributed in unusable form;
a first converter coupled to the storage which converts at least a portion of content from the unusable form into content in a usable form for a limited purpose; and
a second converter which selectively converts at least a portion of the unusable content into usable content, said second converter including:
an identification system for identifying selected content;
a selector for selecting the selected content;
a transmitter for sending an identification of the selected content to a controller responsible for the selected content;
a receiver which receives approval information from the controller for the selected content; and
a decoder which makes the selected content usable in response to the approval information from the controller for the selected content.

2. A system of the type described in claim 1 wherein the content is music which is broadcast and the decoder includes a system for playing the music.

3. A system of the type described in claim 1 wherein the first converter performs the content substantially in real time as the content is received and the second converter provides a long term storage which allows the content to be recalled upon user command.

4. A system of the type described in claim 3 where the content is music and the first converter plays the music promptly after it is received.

5. A system of the type described in claim 4 wherein the music content is stored in long term memory by the second converter and may be played as permitted by digital rights which are provided with the content.

6. A system of the type described in claim 5 wherein the digital rights are provided separate from the transmission of the content.

7. A system of the type described in claim 6 wherein the digital rights are provided in response to a user request requesting rights for long-term storage.

8. A system of the type described in claim 7 wherein the user request includes a payment and, in response to the payment, the user receives a message with appropriate token to use the content in a long-term storage.

9. A system of the type described in claim 7 wherein the system provides different keys for using the content, a first key for using the content as it is received using the first converted and a second key which enables the second converter to store the content in a long-term storage.

10. A method of distributing digital content to a user for rendering where the user can use the content without compensation when converted into a first form and can use the content when converted into a second form only with compensation, the steps of the method comprising:
broadcasting the content in a protected form with an identifier;
allowing conversion of the content into the first form without consideration and allowing conversion of the content into the second form only upon payment of consideration;
receiving a request from the user for a license to use to desired content for consideration, including an identifier of the content desired;
returning a message to the user originating the request with a token which allows the desired content to be converted into the second form.

11. A method including the steps of claim 10 wherein the content is music and the first form is playing of the content substantially contemporaneously with its transmission.

12. A method including the steps of claim 11 wherein the second form for the content is storing the music in a long term storage for playing it upon command.

13. A method including the steps of claim 12 wherein the step of converting the content into the second form includes the step of including rights which govern the use of the content.

14. A method including the steps of claim 11 wherein the step of converting the content into the second form includes the step of authorizing the making of one or more copies of the content.

15. A method including the steps of claim 14 wherein the step of providing a token includes the step of associating the token with the user.

16. A method of providing broadcast music to users including the steps of:
broadcasting the music in a protected format;
providing a rendering system which receives the music in a protected format and plays the music once without the user purchasing additional rights;
allowing a user to identify music which the user wishes to purchase and to send a message indicating that desire;
receiving the message with the identification of the music which the user wishes to purchase and sending an authorization to the user;
in response to the authorization, the user's system allows the identified music to be played more than the once the music could otherwise be played.

17. A method including the steps of claim 16 wherein the step of sending a message by the user includes sending information from which compensation is made for the authorization.

18. A method including the steps of claim 16 wherein the step of sending an authorization to the user includes the identification of the user authorized to play the music.

19. A method including the steps of claim 16 wherein the step of identifying music which the user wishes to purchase includes the step of providing the request through a user interface.

20. A method of providing broadcast content to some users without charge in a first usable form and to other users in a second usable form upon payment by the other users, the steps of the method comprising:
broadcasting the content in a protected form;
permitting some users to use the broadcast without charge by providing a first method of converting the content in the protected form into the first usable form;
receiving a request to purchase selected content from a requesting user along with compensation;
distributing to the requesting user a token which will allow the selected content to be converted into the second usable form to make the selected content available in the second protected form.

21. A method including the steps of claim 20 and further including the step of a user identifying the content which he wishes to purchase, sending a message identifying that music to another system and receiving an authorization from the other system allowing use of the identified music.

22. A method including the steps of claim 21 wherein the step of identifying the selected content the user wishes to purchase includes the step of selecting the content using the buttons on the user's radio.

23. A method including the steps of claim 22, wherein the steps of the method further comprise the step of entering payment information using the radio buttons.

24. A method including the steps of claim 23 wherein the step of entering payment information includes using the user input device includes the step of identifying a credit card number.

25. A method including the steps of claim 24 wherein the method includes using a short-term storage with a rendering device for rendering content contemporaneously with its receipt and a long-term storage system for storing and retrieving the content upon command from a long-term store and the step of transferring music from the short term storage to long-term storage occurs in response to receiving an authorization from the other system.

26. A method including the steps of claim 20 wherein the step of distributing a token includes the step of providing usage conditions wherein the converter enforces the usage conditions.

27. A method including the steps of claim 26 wherein the step of providing usage conditions includes providing a time period during which content may be used.

28. A method including the steps of claim 27 wherein the step of providing usage conditions includes the step of allowing or denying copying the content to another device.

29. A method including the steps of claim 26 wherein the step of providing a token includes the step of providing a token which is usable only on one selected system.

30. A program product which facilitates the receipt and processing of digital content in different modes, the program product comprising:
a first module which receives digital content and stores it in a temporary storage;
a second module coupled to the first module which renders the digital content for a user;
a third module which receives conditions associated with the digital content and controls the use of the second module;
a fourth module which receives a user input and transmits a request for additional rights in the digital content; and
a fifth module which receives a response for additional rights and updates the conditions associated with the third module.

31. A program product of the type described in claim 30 wherein the product further includes a module for receiving a user input with charge information and the fourth module includes a program element for transmitting the charge information.

32. A program product of the type described in claim 30 wherein the content is music and the second module includes a radio system similar to that which is mounted in a motor vehicle and the fourth module for receiving a user input is coupled to push buttons on the radio system, with the push buttons on the radio system being used by the user to select the particular music which the user wishes to acquire long-term rights and the radio system includes a temporary storage for playing the music contemporaneously with the transmission and also includes a long-term storage and the fifth module controls the transfer of music to the long-term storage.
